(19) United States
(12) Patent Application Publication
(10) Pub. No.: US 2002/0152458 A1
(43) Pub. Date: Oct. 17, 2002

(54) Method for establishing a price of an entertainment event by group concensus

(76) Inventors: Mark Kenneth Eyer, San Diego, CA (US); Matthew S. Chang, San Diego, CA (US); Aditya Krishnan, San Diego, CA (US); Andrew M. Proehl, San Francisco, CA (US); David K.L. Yang, San Jose, CA (US); Fred J. Zustak, Poway, CA (US); Peter Rae Shintani, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/798,822

(22) Filed: Mar. 2, 2001

(51) Int. Cl. H04N 7/16; G06F 3/00; H04N 5/445; G06F 13/00

(52) U.S. Cl. 725/1; 725/2; 725/46

(57) ABSTRACT

An information network, such as an interactive set-top box, is provided to a subscriber. Through interaction with the set-top box, a subscriber may indicate his or her interest in a specific television or video program to be offered by a service provider and the price he or she would be willing to pay for it. This information is communicated to the service provider over a communications link, such as the Internet. The service provider uses the information to determine the offer price of the television or video program.

### FIELD OF THE INVENTION

This invention relates generally to the distribution of entertainment media to a viewer on-demand.

### BACKGROUND OF THE INVENTION

Cable and satellite television service providers often offer specific television programs to viewers on a pay-per-view basis. The service provider fixes a price for a particular program based upon previous demand for similar programs and the cost of the program (either copyright fees or production costs) and then offers the program to viewers. If the price is too high, too few viewers will request the program, if the cost is too low, the total revenue generated will be less than optimal.

### SUMMARY OF THE INVENTION

Accordingly, certain embodiments of the current invention provide a method by which a cable or satellite television service provider may obtain information as to the likely revenues that will be generated by a specific program offering prior to actually offering the program.

According to an embodiment of the present invention, an information network, such as an interactive set-top box, is provided to a subscriber. Through interaction with the set-top box, a subscriber may indicate his or her interest in a specific program offering and the price he or she would be willing to pay for it. This information is communicated to the service provider over a communications link, such as the Internet.

With this embodiment of the present invention, the service provider collects information regarding the acceptable pricing for the program. In the preferred embodiment, this information is gathered through the subscriber's navigation and interaction with web pages served by the service provider to the subscriber.

The service provider may poll subscribers, asking a subscriber to bid on a particular program and to commit to purchasing that program if it is subsequently made available at a price equal to or less than the bid.

The service provider may operate a web site, in which an inventory of programs, such as movies or forthcoming events, is categorized and listed (with descriptions, reviews etc.). The web site may be arranged so that a subscriber can register his or her level of interest in a particular program and the price he or she would be willing to pay. The subscriber may also request other programs not listed.

The service provider determines which programs to offer based upon the level of interest, the cost of the program, available bandwidth for delivery and other factors.

Accordingly, the service provider may optimize the efficiency of program delivery, which results in a combination of higher profits for the operator and lower prices for the subscriber.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The novel features believed characteristic of the invention are set forth in the claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 shows an exemplary plot of the relationship between the price of a program and the number of subscribers who will purchase the program. It also shows the resulting relationship between the revenue generated and the price.

FIG. 2 is a block diagram of an exemplary interactive television (TV) system, in accordance with the present invention.

FIG. 3 shows a system configuration for an exemplary digital set-top box, in accordance with an embodiment of the present invention.

FIG. 4 illustrates an exemplary method for program price establishment, in accordance with the present invention.

### DESCRIPTION OF THE INVENTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several Views of the drawings.

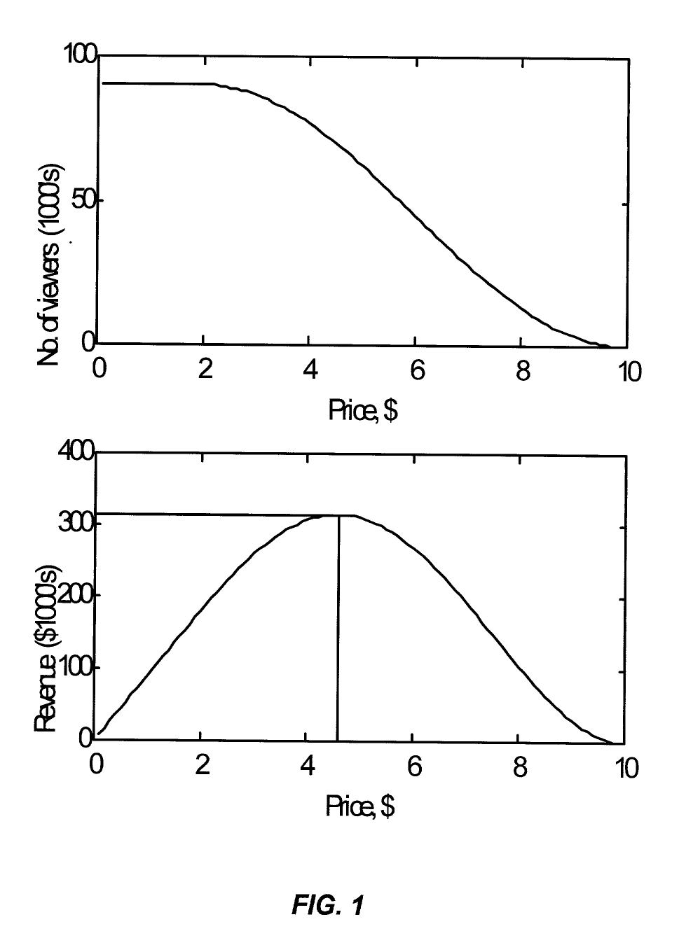

FIG. 1 shows an exemplary plot of the relationship between the price of a program and the number of subscribers who will purchase the program. It also shows the resulting relationship between the revenue generated and the price. The upper plot in FIG. 1 depicts an exemplary relationship between the price charged to the subscriber for a particular program and the number of subscribers who will purchase the program at that price or at a lower price. When the price is low, less than $2, for example, a high number of subscribers (90,000 in this example) will purchase the program. As the price increases, fewer and fewer subscribers will purchase the program. Above $10, no subscribers will purchase the program. The revenue generated by the program is determined by the number of subscribers purchasing the program multiplied by the price charged for the program. The relationship between the revenue generated and the price charged is depicted in the lower plot of FIG. 1. In this example, the maximum revenue generated will be $315,000 and will occur when the program is offered at a price of $4.60.

This knowledge enables the service provider to compare this particular program with other programs and determine which program will provide the highest net return.

If the program contains advertising, it is likely that the revenue received from advertisers is related to the number of subscribers purchasing the program. This revenue, and the cost of the program, may also be considered when determining the net income resulting from delivery of the program.

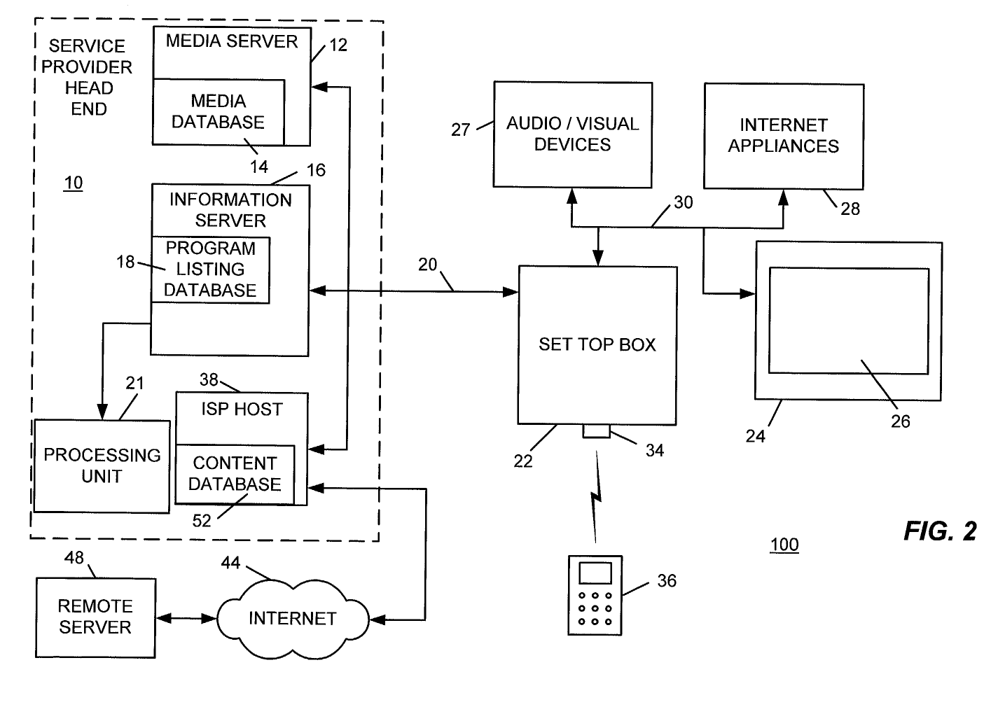

Referring now to FIG. 2, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as broadcast sporting events, interviews with the actors, games, advertisements, available merchandise, associated Web pages, interactive games and other related content. The system 100 also includes an information server 16 and a program listing database 18. The program listing database 18 may contain a list of scheduled broadcast programs, programs available on-demand and programs that could be made available on demand if there was sufficient interest from subscribers. The system 100 also includes a subscriber information database 19, in which is stored the reported subscriber interest in currently offered and on-demand programs that may be offered in the future. The subscriber information database 19 is linked or related to the program listing database 18. In one embodiment, the information in the subscriber information database 19 is gathered through the subscriber's navigation and interaction with web pages served by the service provider to the subscriber. These web pages may be served from the information server 16, or from ISP Host 38. The subscriber may access the web pages at any time, or may be prompted, by the service provider, to respond to a questionnaire. For each program, the information may include the subscriber's interest level (low, medium, high for example), the price a subscriber might pay, the likelihood of purchase on a particular day or at a particular time. The system 100 also includes a processing unit 21, which is configured to use the information in the subscriber information database 19 to calculate a preferred offer price for programs offered to the subscriber for purchase. The processing unit 21 may use additional information such as program costs, likely advertising revenue and promotional value, to determine the preferred offer price. The processing unit 21 may also be configured to determine which programs are offered to the subscriber for purchase.

Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and information server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, web pages, etc. The STB 22 may be coupled to the TV 24 and various other audio/visual devices 27 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture may be utilized to enable interoperability among devices on a network regardless of the manufacturer of the device if the manufacturers agree to adhere to an industry standard. The STB 22 runs an operating system suitable for a home network system.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 52. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 2 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 2 may actually reside in other locations, but from the perspective of the user of STB 22, the service provider 10 serves as a portal to the services shown. Those skilled in the art will appreciate that the illustration of FIG. 2 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Many of those details can be found in the publicly available CableLabs OpenCable™ specification or in the text “OpenCable Architecture (Fundamentals)” by Michael Adams, Cisco Press, November 1999.

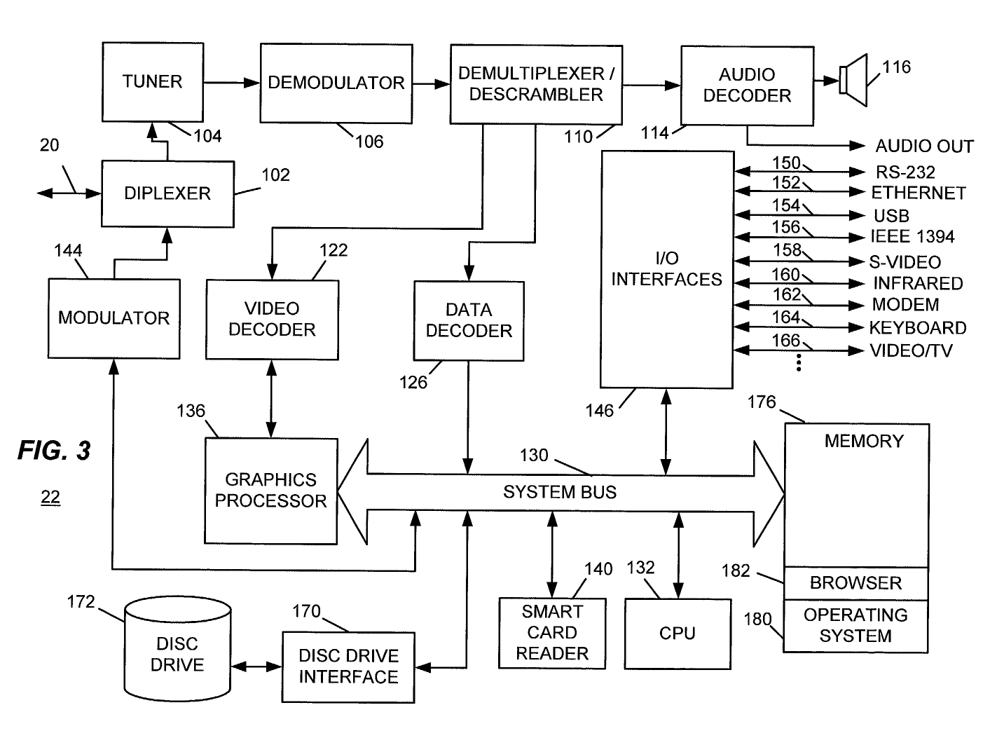

Referring now to FIG. 3, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also descrambles scrambles information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-LINK™) or IEEE 1394 port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high-speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publicly available. Of course it is envisioned that the modem can be built into the set-top box.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. The infrared port 160 can be embodied as an infrared receiver 34 as illustrated in FIG. 2, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD RAW drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security, and a separate video path. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or browser software may permanently reside in ROM, EEPROM or Flash memory, for example. The browser software 182 may operate as the mechanism for viewing not only web pages on the Internet, and can serve as the mechanism for viewing an Electronic Program Guide (EPG) formatted as an HTML document. The browser 182 can be used to view and fill out HTML questionnaires regarding the subscriber's interest in programs that may be offered on-demand in the future. This information is collected by the service provider and stored in the subscriber information database, described above.

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside, e.g., browsing, email, EPG, Video On Demand (VOD), rich multimedia applications, pay per view, etc. The current invention can be utilized with any suitable set-top box software and hardware architecture.

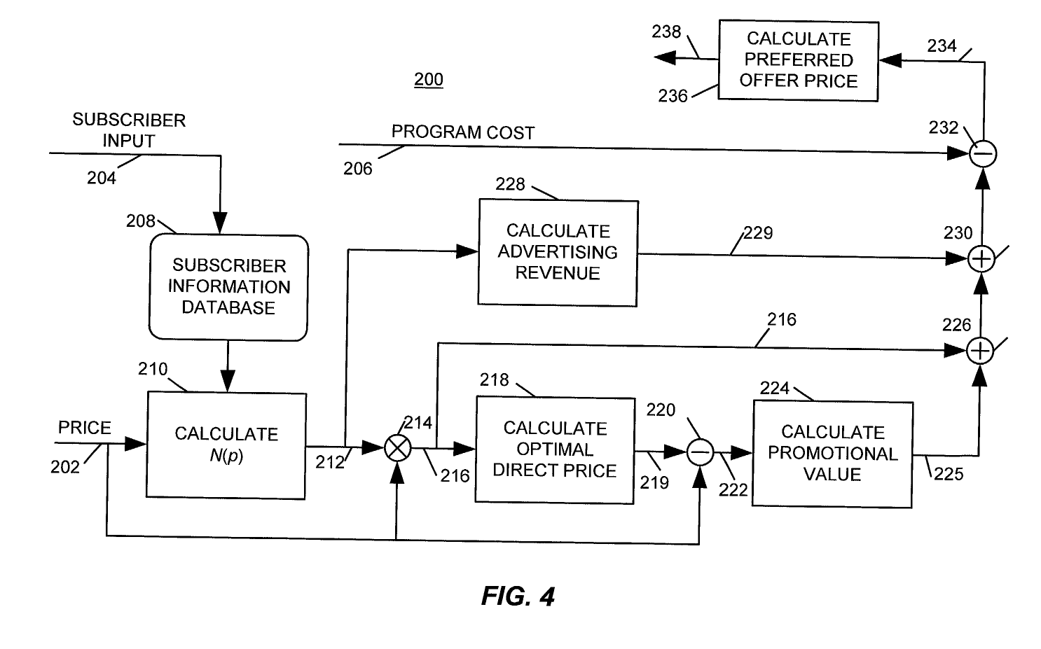

In one embodiment, the service provider calculates the value of movie as follows. FIG. 4 shows an exemplary mode of operation 200 of the present invention. Subscriber information 204 is collected from subscribers and stored in the subscriber information database 208. The expected number of purchasers, N, is calculated at block 210 as a function of the price p (202) charged to the subscribers. The expected number of purchasers is depicted as 212. The direct revenue generated, R_{d} (depicted as 216), is obtained by multiplying the product of the price charged 202 and the number of purchasers 212 at multiplier 214. The resultant Direct Revenue Generated 216 is

R_{d}=p×N(p)

The optimal direct price pₘₐₓ (219), which maximizes the direct revenue, is calculated at calculation block 218. The advertising revenue, Rₐ (229) is calculated at calculation block 228 and is a function of the number of purchasers, N (212), since generally advertisers will pay more to advertise in during programs with a larger audience. The function dependence of Rₐ upon the number of purchasers may be determined from historical data or by polling potential advertisers. The program also has a promotional value, Rₚ (225), which is calculated at calculation block 224. For example, if a recent popular movie is offered at a price perceived to be low, advertisement of the offer may attract more subscribers. The promotion value, Rₚ, can be considered as a function of the difference 222 between the offered price p (202) and the optimal direct price pₘₐₓ (219). The difference 222 is calculated at subtractor 220. The functional dependence of Rₐ may be determined with reference to historical data. The value, V(p) (234), of the movie to the service provider may then be calculated as the sum of signals 216, 225 and 229 less the cost of the program 206. This gives

$$\begin{matrix}V ( p ) = {R}_{d} + {R}_{a} + {R}_{p} - C \\ = p \times N ( p ) + {R}_{a} ( N ( p ) ) + {R}_{p} ( {p}_{max} - p ) - C ,\end{matrix}$$

where C is the cost of the movie. This is calculated using summers 226 and 230 and subtractor 232. Since the function N(p) is known from information in the subscriber information database, the preferred offer price 238 for the movie may be determined by maximizing the value V(p) (234) with respect to the price p (202) at calculation block 236. This calculation may be performed for each movie in turn, thereby providing the service provider with a method for deciding which movie(s) to broadcast.

The above discussion is simplified, of course, and other factors, such as the time and date of the broadcast, may need to be considered also. Also, the interaction between movies may need to be considered. This is the case, for example, when multiple movies are broadcast simultaneously, or when subscribers have a limited budget for purchasing movies.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and can be stored in any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of establishing a preferred offer price for a television program to be offered by a service provider for delivery to a plurality of interactive set-top boxes for viewing by subscribers, said method comprising:
gathering subscriber information related to the subscribers' interest in the television program via a communication link to the plurality of interactive set-top boxes;
from said subscriber information, calculating an estimated direct revenue generated from subsequent purchases of the television program by the subscribers, as a function of an offer price for the television program and performed by a processing means controlled by the service provider;
determining by the processing means an optimal direct price at which said direct revenue is maximized, wherein said preferred offer price is determined according to said optimal direct price.

2. A method as in claim 1, wherein said communication link comprises the Internet.

3. A method as in claim 1, wherein said preferred offer price is determined according to said optimal direct price and according to a cost of the television program.

4. A method as in claim 3, wherein the television program comprises a plurality of television programs each having a preferred offer price and the service provider determines to offer the television program to the subscribers according the preferred offer price for each of the plurality of television programs.

5. A method as in claim 1, wherein said calculating an estimated direct revenue comprises:
calculating, from said subscriber information, an estimated number of subsequent purchases of the television program by subscribers as a function of the offer price for the television program; and
calculating an estimated direct revenue by multiplying said estimated number of subsequent purchases by said offer price for the television program.

6. A method as in claim 5, further comprising:
calculating an estimated advertising revenue derived from the delivery of the television program, wherein said estimated advertising revenue is dependent upon said estimated number of subsequent purchases and wherein said preferred offer price is determined according to said optimal direct price and said estimated advertising revenue.

7. A method as in claim 1, further comprising:
calculating an estimated promotional value derived from the delivery of the television program, wherein said estimated promotional value is dependent upon said optimal direct price and the offer price and wherein said preferred offer price is determined according to said optimal direct price and said estimated promotional value.

8. A method as in claim 1, wherein said gathering subscriber information further comprises:
transmitting an electronic questionnaire via said communication link to at least one of the plurality of interactive set-top boxes for completion by a subscriber of the subscribers;
receiving the subscriber's responses to said electronic questionnaire via said communication link; and
storing the subscriber's responses to said electronic questionnaire in a subscriber information database.

9. A method as in claim 1, wherein said subscriber information includes a maximum price a subscriber of the subscribers would pay for delivery of the television program to an interactive set-top box of the plurality of set-top boxes corresponding to the subscriber.

10. A method as in claim 9, wherein said subscriber information indicates whether the subscriber has agreed to purchase the television program if it is subsequently offered at a price less than or equal to said maximum price.

11. A system for establishing a preferred offer price for a television program of a plurality of television programs to be offered by a service provider for delivery to a plurality of interactive set-top boxes for viewing by subscribers, said system comprising:
a database of subscriber information relating to the subscribers; and
a processing unit operably connected to said database of subscriber information and configured to determine the preferred offer price for a television program according to said subscriber information.

12. A system as in claim 11, wherein said processing unit is configured to select for offering to the subscribers one or more television programs of the plurality of television programs according to the preferred offer price for each television program of the one or more television programs and a cost for each television program of the one or more television programs.

13. A system as in claim 11, further comprising:
an information server, operably connected to said database of subscriber information; and
a communication link, operable to connect said information server to at least one interactive set-top box of the plurality of interactive set-top boxes;
wherein said information server is operable to update said database of subscriber information in response to data received via said communication link.

14. A system as in claim 11, further comprising:
a media database containing one or more television programs; and
a media server, operable to delivery the one or more television programs from said media database to the at least one interactive set-top box of the plurality of interactive set-top boxes for viewing by the subscribers.

15. A system as in claim 13, wherein said communication link includes one or more of a coaxial cable network, a fiber optic cable network, a telephone system, a twisted pair, a satellite communication system, a radio frequency (RF) system, a microwave system, a wireless system, and a combination of wired and wireless systems.

16. A system as in claim 13, wherein said information server utilizes an Internet Protocol and wherein said subscriber information is obtained through a subscriber's navigation and interaction with web pages provided by said information server to the subscriber via the at least one interactive set-top box.

17. A system as in claim 11, wherein said database of subscriber information contains information regarding a subscriber's level of interest in the television program.

18. A system as in claim 11, wherein said database of subscriber information contains information regarding the maximum price the subscriber would pay to view the television program.

19. An electronic storage medium storing instructions which, when executed on a programmed processor, carry out a method of establishing a preferred offer price for a television program to be offered by a service provider for delivery to a plurality of interactive set-top boxes for viewing by subscribers, said method comprising:
gathering subscriber information related to the subscribers' interest in the television program via a communication link to the plurality of interactive set-top boxes;
from said subscriber information, calculating an estimated direct revenue generated from subsequent purchases of the television program by the subscribers, as a function of an offer price for the television program and performed by a processing means controlled by the service provider;
determining by the processing means an optimal direct price at which said direct revenue is maximized, wherein said preferred offer price is determined according to said optimal direct price.

20. The electronic storage medium as in claim 19, wherein said communication link comprises the Internet.

21. The electronic storage medium as in claim 19, wherein said preferred offer price is determined according to said optimal direct price and according to a cost of the television program.

22. The electronic storage medium as in claim 19, wherein said calculating an estimated direct revenue comprises:
calculating, from said subscriber information, an estimated number of subsequent purchases of the television program by subscribers as a function of the offer price for the television program; and
calculating an estimated direct revenue by multiplying said estimated number of subsequent purchases by said offer price for the television program.

23. The electronic storage medium as in claim 22, further comprising:
calculating an estimated advertising revenue derived from the delivery of the television program, wherein said estimated advertising revenue is dependent upon said estimated number of subsequent purchases and wherein said preferred offer price is determined according to said optimal direct price and said estimated advertising revenue.

24. The electronic storage medium as in claim 19, further comprising:
calculating an estimated promotional value derived from the delivery of the television program, wherein said estimated promotional value is dependent upon said optimal direct price and the offer price and wherein said preferred offer price is determined according to said optimal direct price and said estimated promotional value.

25. The electronic storage medium as in claim 19, wherein said gathering subscriber information further comprises:
transmitting an electronic questionnaire via said communication link to at least one of the plurality of interactive set-top boxes for completion by a subscriber of the subscribers;
receiving the subscriber's responses to said electronic questionnaire via said communication link; and
storing the subscriber's responses to said electronic questionnaire in a subscriber information database.

26. A method of establishing a preferred offer price for a television program to be offered by a service provider for delivery to a plurality of interactive set-top boxes for viewing by subscribers, said method comprising:
presenting a subscriber with a survey requesting information regarding the subscriber's interest in a television program, said survey including a request for a maximum price the subscriber is willing to pay for the television program;
sending subscriber information in response to said survey to the service provider for computation of an offering price for the television program over a communication link.

27. The method as in claim 26, further comprising:
at the service provider, gathering subscriber information related to the subscribers' interest in the television program via said communication link to the plurality of interactive set-top boxes;
from said subscriber information, calculating an estimated direct revenue generated from subsequent purchases of the television program by the subscribers, as a function of an offer price for the television program and performed by a processing means controlled by the service provider;
determining by the processing means an optimal direct price at which said direct revenue is maximized, wherein said preferred offer price is determined according to said optimal direct price.

28. A method as in claim 27, wherein said communication link comprises the Internet.

29. A method as in claim 27, wherein said preferred offer price is determined according to said optimal direct price and according to a cost of the television program.

30. A method as in claim 27, wherein the television program comprises a plurality of television programs each having a preferred offer price and the service provider determines to offer the television program to the subscribers according the preferred offer price for each of the plurality of television programs.

31. A method as in claim 27, wherein said calculating an estimated direct revenue comprises:
calculating, from said subscriber information, an estimated number of subsequent purchases of the television program by subscribers as a function of the offer price for the television program; and
calculating an estimated direct revenue by multiplying said estimated number of subsequent purchases by said offer price for the television program.

32. A method as in claim 31, further comprising:
calculating an estimated advertising revenue derived from the delivery of the television program, wherein said estimated advertising revenue is dependent upon said estimated number of subsequent purchases and wherein said preferred offer price is determined according to said optimal direct price and said estimated advertising revenue.

33. A method as in claim 27, further comprising:
calculating an estimated promotional value derived from the delivery of the television program, wherein said estimated promotional value is dependent upon said optimal direct price and the offer price and wherein said preferred offer price is determined according to said optimal direct price and said estimated promotional value.

34. A method as in claim 27, wherein said gathering subscriber information further comprises:
transmitting an electronic questionnaire via said communication link to at least one of the plurality of interactive set-top boxes for completion by a subscriber of the subscribers;
receiving the subscriber's responses to said electronic questionnaire via said communication link; and
storing the subscriber's responses to said electronic questionnaire in a subscriber information database.

35. A method as in claim 27, wherein said subscriber information includes a maximum price a subscriber of the subscribers would pay for delivery of the television program to an interactive set-top box of the plurality of set-top boxes corresponding to the subscriber.

36. A method as in claim 35, wherein said subscriber information indicates whether the subscriber has agreed to purchase the television program if it is subsequently offered at a price less than or equal to said maximum price.
